(19) United States
(12) Patent Application Publication
(10) Pub. No.: US 2026/0129403 A1
(43) Pub. Date: May 7, 2026

(54) LOCATION-BASED TRIVIA CONTEST WITH MOOD-RESPONSIVE CAPABILITIES

(71) Applicant: GM GLOBAL TECHNOLOGY OPERATIONS LLC, Detroit, MI (US)

(72) Inventors: Nissim Gean, Netanya (IL); Elior Hadad, Ness Tziona (IL); Gaurav Talwar, Novi, MI (US); Shai Natanzon, Yavne (IL)

(73) Assignee: GM GLOBAL TECHNOLOGY OPERATIONS LLC, Detroit, MI (US)

(21) Appl. No.: 18/937,453

(22) Filed: Nov. 5, 2024

(51) Int. Cl. H04W 4/029

(52) U.S. Cl. CPC H04W 4/029

(57) ABSTRACT

A method, or methods, of using location-based trivia with mood-responsive capabilities in a vehicle includes initiating one or more location-based trivia questions based on global positioning system (GPS) coordinates and detecting active players using one or more microphones within the vehicle. Based on the player names and seat locations, the method includes customizing the trivia questions for one or more of the seat locations. The method may further include assessing a mood of the players by analyzing vocal tone and speech patterns and basing one or more of the trivia questions on the mood, and/or querying player names via the microphone(s) at a start of the trivia questions, and/or configuring the number of channels and processing chain topology based on the detected number of active players and their seat locations.

### INTRODUCTION

The present disclosure relates to method, or methods, of using location-based trivia with mood-responsive capabilities. Currently, no technologies exist for using location-based trivia with mood-responsive capabilities.

### SUMMARY

A method of using location-based trivia with mood-responsive capabilities is disclosed herein. Embodiments of the method, including performing, one or more location-based trivia, based on global positioning system (GPS) coordinates, and detecting vocal-based active players detection, based on microphones within vehicle A and/or B. Based on the detection of players names and their seat locations, the method includes customizing the trivia for one or more seat locations. The methods may further include, assessing a mood of passengers by analyzing vocal tone and speech patterns, and basing one or more trivia questions based on the mood assessed of passengers.

The methods may further include querying players names via one or more microphones at a start of the trivia. The methods may further include configuring the number of channels and processing chain topology based on the detected number of active players and their seat locations.

The methods may further include, wherein the GPS retrieves relevant trivia questions based on a current location, a route, and/or upcoming destinations. The methods may further include using an audio and response processing system continuously to ensure clear voice capture and providing accurate response analysis using one or more of the following components, one of: acoustic echo cancellation; acoustic source separation; speech recognition engine; and/or one or more large language models (LLMs). The methods may further include addressing, via one or more contest managers addresses, players by name and/or tailoring questions and/or tasks based on their specific seats of the players.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic view of a vehicle and cellular, or other, communication system which may be linked with one or more clouds.

FIG. 2 is a schematic flow chart of a method or methods for using location-based trivia with mood-responsive capabilities.

FIG. 3 is a schematic flow chart of a method or methods for using location-based trivia with mood-responsive capabilities.

### DETAILED DESCRIPTION

Referring to the drawings, like reference numbers refer to similar components, wherever possible. In general, using location-based trivia with mood-responsive capabilities. The present disclosure relates to method, or methods, of using location-based trivia with mood-responsive capabilities. The system identifies the passengers and their locations within the vehicle, automatically, using source localization and voice recognition. Moreover, it also dynamically adjusts the game based on both the current environment (location and views) and the passengers’ emotional responses.

Through continuous analysis of speech patterns, tone, and detected mood, the system can alter the difficulty, tone, and type of questions asked, providing a more engaging and personalized trivia experience. This may include, without limitation: tailoring questions relative to the seat of one or more passengers, and/or working on dynamic configuration based on one or more players information, and/or the locations, and/or the mood-based information, and/or large language model(s), and/or audio processing of passengers’ responses.

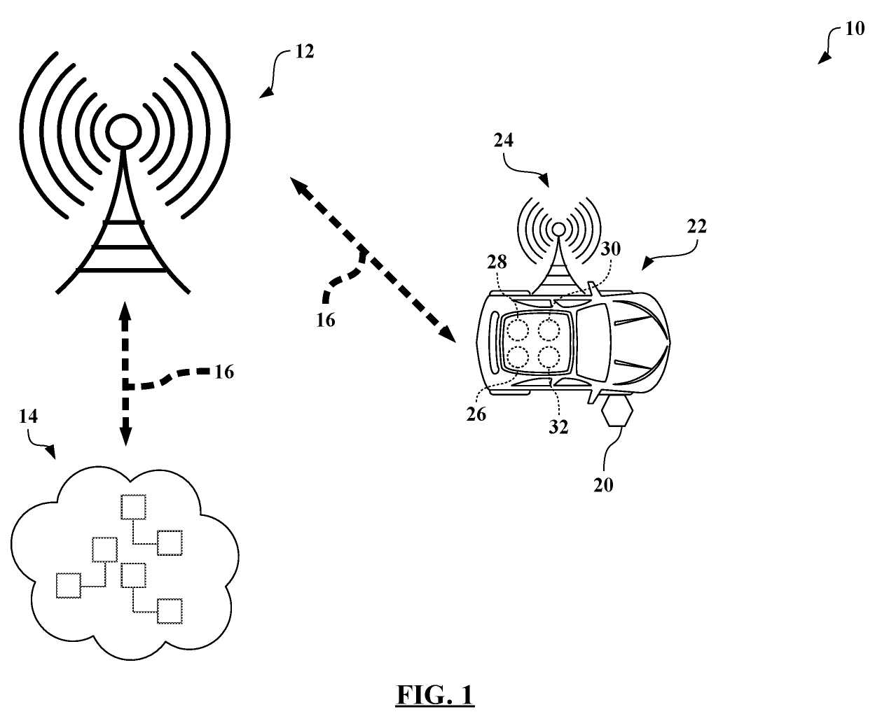

FIG. 1 schematically illustrates a connectivity network or connectivity system 10. The connectivity system 10 includes numerous components, only some of which are listed, and/or shown, herein. A remote or cellular communications system, or cellular network 12, which may be representative of many types of communications protocols, including, without limitation: cellular, satellite, Wi-Fi, Bluetooth, ultra-wideband (UWB) or other communications recognizable to those having ordinary skill in the art. UWB is a radio-based communication technology for short-range use and fast and stable transmission of data.

A centralized location 14 is shown highly schematically, but may be representative of many different structures, clouds, servers, or elements, as will be recognized by skilled artisans. The centralized location 14 represents systems that communicate with some, or all the other systems, and/or objects described herein. The centralized location 14 includes numerous controllers 20. Additionally, the centralized location 14 may be a back office (BO) of the manufacturer of one or more vehicles 22.

Several transfer protocols or transfers 16 are schematically illustrated. These transfers 16 may include, without limitation: cellular, Wi-Fi, wired networks, over-the-air (OTA), other transport protocols, including machine to machine (M2M), or other telematics equipment, or other systems recognizable by those having ordinary skill in the art. M2M systems use point-to-point communications between machines, sensors, and hardware over cellular, Wi-Fi, or wired networks.

The drawings and figures presented herein are diagrams, are not to scale, and are provided purely for descriptive purposes. Thus, any specific or relative dimensions or alignments shown in the drawings are not to be construed as limiting. While the disclosure may be illustrated with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting the claims or the description.

The term vehicle is broadly applied to any moving platform. Vehicles into which the disclosure may be incorporated include, for example and without limitation: passenger or freight vehicles; autonomous driving vehicles; industrial, construction, and mining equipment; and various types of aircraft.

All numerical values of parameters (e.g., of quantities or conditions) in this specification, including the appended claims, are to be understood as being modified in all instances by the term “about,” whether or not the term actually appears before the numerical value. About indicates that the stated numerical value allows some slight imprecision (with some approach to exactness in the value; about or reasonably close to the value; nearly). If the imprecision provided by about is not otherwise understood in the art with this ordinary meaning, then about as used herein indicates at least variations that may arise from ordinary systems of measuring and using such parameters. In addition, disclosure of ranges includes disclosure of all values and further divided ranges within the entire range. Each value within a range and the endpoints of a range are hereby all disclosed as separate embodiments.

When used herein, the term “substantially” often refers to relationships that are ideally perfect or complete, but where manufacturing realities prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans will recognize the amount of acceptable variance. For example, and without limitation, coverages, areas, or distances may generally be within 10% of perfection for substantial equivalence. Similarly, relative alignments, such as parallel or perpendicular, may generally be considered to be within 5%.

A generalized control system, computing system, or controller 20 is operatively in communication with relevant components of all systems, and recognizable by those having ordinary skill in the art. The controller 20 includes, for example and without limitation, a non-generalized, electronic control device having a preprogrammed digital computer or processor, a memory, storage, or non-transitory computer-readable storage medium used to store data such as control logic, instructions, lookup tables, etc., and a plurality of input/output peripherals, ports, or other communication protocols.

Furthermore, controller 20 may include, or be in communication with, a plurality of sensors. The controller 20 is configured to execute or implement all control logic or instructions described herein and may be communicating with any sensors described herein or recognizable by skilled artisans.

Any of the systems described herein may be executed by one or more controllers 20. Note that this algorithm may run on, generally, less expensive controllers 20. The vehicle 22 is shown in FIG. 1, but there may be other vehicles 22 that are not shown. There may be one or more antennas 24 on the vehicle 22.

There may be several participants with the vehicle 22. Including, without limitation, a first participant 26, a second participant 28, a third participant 30, a fourth participant 32. Note that the participants 26, 28, 30, 32, may be located in any of the one or more seats of the vehicle 22.

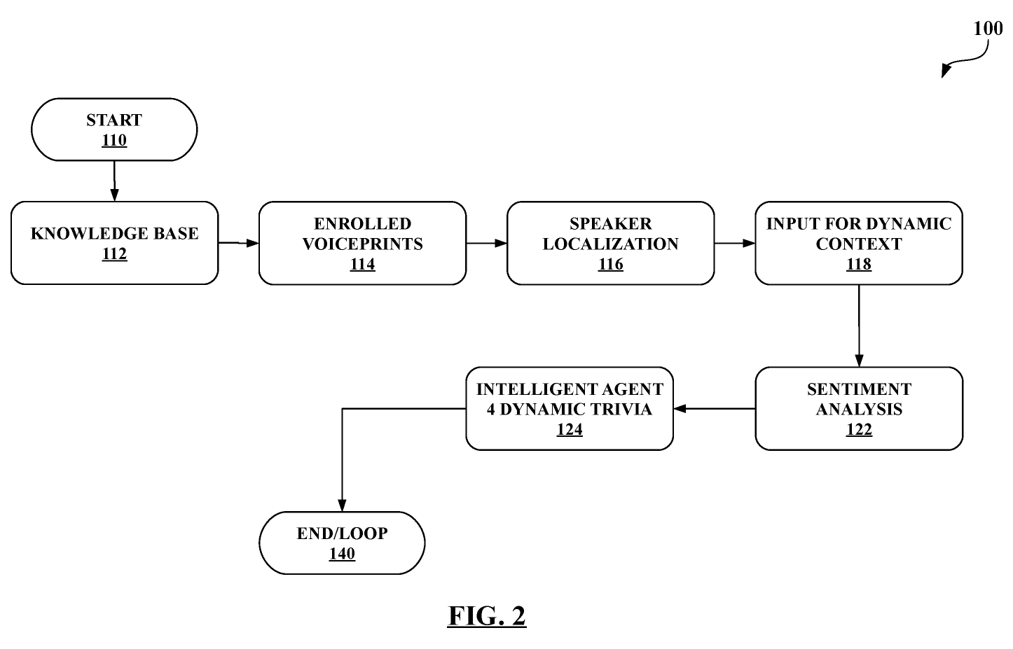

FIG. 2 is a schematic flow chart diagram of a method 100, or methods, for using location-based trivia with mood-responsive capabilities in one or more vehicles 22.

Step 110: START. At step 110, method 100 initializes or starts. Method 100 may begin operation when called upon by one or more controllers 20, may be constantly running or may be looping iteratively.

Step 112: KNOWLEDGE BASE. At step 112, method 100 queries a knowledge base. This may include, without limitation, an internet search, personal context, and/or prior history, additional details, or information, would be recognized by those having ordinary skill in the art.

Step 114: ENROLLED VOICEPRINTS. At step 114, method 100 sends notes where enrolled voiceprints are located. This may include, without limitation, detecting with one or more microphones with the vehicle 22, where the occupants are located. This may represent the participants 26, 28, 30, 32, or others within the vehicle 22.

This may include, without limitation, a processing chain, or processing chain topology, which in computer science refers to a sequence of tasks including preprocessing, data reduction, segmentation, object recognition, and image understanding. It involves the use of optimization techniques as auxiliary tools throughout the different steps of image processing. The number of channels, or total number of channels, will be recognized by those having ordinary skill in the art.

Note that, late at night, only the driver of the vehicle 22 may be awake while other passengers remain asleep. Therefore, the trivia capability will not be proactively offered by a digital assistant. Additionally, during the day, all occupants may not be interacting with each other, such as by watching their phones, yawning, or otherwise being disengaged.

The digital assistant (also as a virtual assistant, virtual digital assistant, or mobile assistant) is technology designed to assist users by answering questions and processing simple tasks. They digital assistants are designed to free users from spending time on routine functions that do not require human intervention.

In this scenario, the digital assistant can may initiate one or more trivia to questions to engage the occupants. An intelligent agent keeps track of people’s preferences such as inclination towards specific trivia topics, e.g., biographies, history, general knowledge/awareness, etc.

Step 116: SPEAKER LOCALIZATION. At step 116, method 100 determines where the speakers are located in the vehicle 22, and, generally, uses that the location of the speakers to assign locations of the enrolled voiceprints and/or participants 26, 28, 30, 32.

Step 118: INPUT FOR DYNAMIC CONTEXT. At step 118, method 100, the dynamic context, may be, without limitation, of an expression is that the information that is available at the time that the expression is evaluated. The dynamic context represents aspects of the environment that may change during the evaluation, of or that might be changed by environmental factors other than the implementation itself. Many people, without limitation, view the static context as part of the dynamic context, but others do not.

Step 122: SENTIMENT ANALYSIS. At step 122, method 100 judges the sentiment in the vehicle 22, which may include, without limitation, voiceprints or mood thoughts. Those having ordinary skill in the art will recognize additional elements that may be used. Sentiment means, generally, a view of, or attitude toward, a situation or event and/or an opinion.

Step 124: INTELLIGENT AGENT FOR DYNAMIC TRIVIA. At step 124, method 100 provides one or more intelligent agents for dynamic trivia. Intelligent agents, may include, without limitation: programs that can perform tasks or services on their own, based on their environment, user input, and/or experiences. By using artificial intelligence, one or more quiz wizards may, or contest managers, generate creative questions, which can surprise passengers, and stimulate their curiosity. This may further include, without limitation, steps that will be recognized by those having ordinary skill in the art.

Step 140: END/LOOP. At step 140, the method 100 ends or loops. Ending/looping may include proceeding back to start step 110 or waiting until called upon to run again, by one of the controllers 20 or another portion of the connectivity system 10.

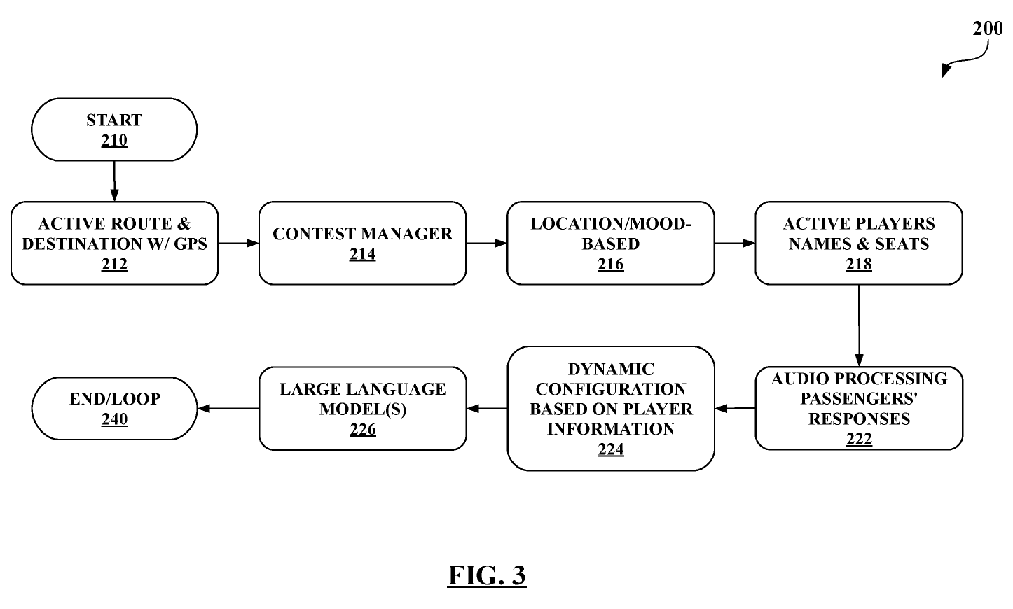

FIG. 3 is a schematic flow chart diagram of a method 200, or methods, for using location-based trivia with mood-responsive capabilities in one or more vehicles 22.

Step 210: START. At step 210, method 200 initializes or starts. Method 200 may begin operation when called upon by one or more controllers 20 may be constantly running or may be looping iteratively.

Step 212: ACTIVE ROUTE AND DESTINATION WITH GPS. At step 212, method 200 this may include several steps, as would be recognized by those having ordinary skill in the art. Active route and destination example: the system is aware of the active route and/or the destination – such as, for example without limitation, Mt. Rushmore – such that the system, without limitation, may trigger a trivia session to stimulate interest in the landmark, “When was it built?” “What are names of US presidents – with faces carved on the mountain?” Note that this may include a GPS receiver.

One or more large language models (LLMs) can be used to further augment the experience by means of an evolving dialog. The large language model can also automatically pivot the level of trivia questions (difficult, medium, general awareness).

Note that one or more user travel histories may be used. For example, and without limitation, if someone has recently traveled to Sedona, Arizona, and during another active route to the same destination, a question can be part of the trivia to provide a personalized experience. For example, and without limitation, a contest manager may ask: “Here is a question, [Player], when was the last time you traveled to Sedona?”

Step 214: CONTEST MANAGER. At step 214, method 200 feeds into the contest manager. The contest manager may organize and conduct the contest in accordance with generally accepted rules, which will be recognized by those having ordinary skill in the art.

Step 216: LOCATION/MOOD-BASED. At step 216, method 200 determines one or more of the locations and/or the mood in the vehicle 22. This may include assessing the mood of the occupants, or participants 26, 28, 30, 32, and addressing questions based on the relative moods.

Step 218: ACTIVE PLAYERS NAMES AND SEATS. At step 218, method 200 determines where the active players are, and their names and/or their seats. This may include, without limitation, one or more of the participants 26, 28, 30, 32. Also, this may include use sensing the locations of the participants 26, 28, 30, 32 and addressing specific questions based on their locations.

Voice activity detection (VAD) refers, generally, to the process of detecting pauses or lack of speech in a voice signal. It is used in voice compression systems to reduce bandwidth by transmitting fewer or no packets during periods of silence. VAD is implemented using a function called a voice activity detector, which helps in halving the bandwidth used by identifying periods of no voice activity. It may use a detector to identify who is active and when, and/or for transcription purposes.

Step 222: AUDIO PROCESSING PASSENGERS' RESPONSES. At step 222, method 200 audio processes the passengers’ responses. This may include, without limitation, sound systems and engineering capabilities required for safe, reliable passenger support. Note that this may include, without limitation, one or more of the participants 26, 28, 30, 32, and the processing of their responses.

Step 224: DYNAMIC CONFIGURATION BASED ON PLAYER INFORMATION. At step 224, method 200, this may include, without limitation, working on details of questions and/or trivia locations. Additionally, this may include working on questions relevant to the players locations within the vehicle 22, such as the participants 26, 28, 30, 32, or others within the vehicle 22.

Describes that the system can re-configure itself by re-selecting the number of inputs and outputs channels (i.e., re-select the exact set of microphones and loudspeakers within the vehicle), and the processing chain topology based on the detected number of active players and their location within the vehicle. This will optimize the acoustic performance in this “cocktail party” environment, which means better sources separation, better noise and echo cancelation to improve interaction between the players and the system.

Step 226: LARGE LANGUAGE MODEL(S). At step 226, method 200, may include, without limitation, implementing one or more large language models (LLMs). This may further include, without limitation: acoustic echo cancellation, acoustic source separation, and/or speech recognition engine.

In the next stage, the trivia game is constructed. After collecting the material for generating the trivia game, the questionnaires in the game need to be created. The questionnaires are built based on the LLMs technology. An example of implementing LLMs is based on one or more transformers.

The participants/players responses to the trivia game together with additional audio information are captured by the microphones in the vehicle. To enhance the audio signals, an audio signal processing system is activated. The system may further include, without limitation: acoustic echo cancellation, acoustic source separation, audio processing system, acoustic noise reduction, and/or speech recognition engine.

The LLMs may serve a different purpose than the acoustic audio processing stage – such as adaptive echo cancellation and noise reduction. The LLMs role is to generate trivia questions and understand the meaning of the text – for example, and without limitation, as a conversational agent and/or for sentiment analysis.

Acoustic echo cancellation (AEC) is a technology that removes echoes and unwanted sounds from audio signals. Audio, or acoustic, source separation refers to the process of extracting individual sound signals from a mixture of signals in audio recordings. It is a signal processing technique used to separate and isolate different sound sources, such as voices or instruments, from a recorded audio signal. A speech recognition engine is, or maybe, an extensive software library that allows anyone to quickly and easily interact with devices and/or machines by talking.

Large language models, also known as LLMs, are very large deep learning models that are pre-trained on vast amounts of data. The underlying transformer is a set of neural networks that consist of an encoder and a decoder with self-attention capabilities. The encoder and decoder extract meanings from a sequence of text and understand the relationships between words and phrases in it.

Step 240: END/LOOP. At step 240, the method 200 ends or loops. Ending/looping may include proceeding back to start step 210 or waiting until called upon to run again, by one of the controllers 20 or another portion of the connectivity system 10.

The detailed description and the drawings or figures are supportive and descriptive of the subject matter herein. While some of the best modes and other embodiments have been described in detail, various alternative designs, embodiments, and configurations exist.

“A,” “an,” “the,” “at least one,” and “one or more,” are used interchangeably to indicate that at least one of the items is present. A plurality of such items may be present unless the context clearly indicates otherwise.

Furthermore, any examples shown in the drawings, or the characteristics of various examples mentioned in the present description, are not necessarily to be understood as examples independent of each other. Rather, it is possible that each of the characteristics described in one of the examples of an embodiment can be combined with one or a plurality of other desired characteristics from other examples, resulting in other examples not described in words or by reference to the drawings. Accordingly, such other examples fall within the framework of the scope of the appended claims.

1. A method of using location-based trivia in a vehicle with mood -responsive capabilities, comprising:
playing one or more location-based trivia questions in the vehicle, based on global positioning system (GPS) coordinates from a GPS receiver;
detecting player names and corresponding seat locations of active players in the vehicle using vocal-based active players detection, based on one or more microphones within the vehicle; and
based on the detection of players names and their corresponding seat locations, customizing the trivia questions for one or more of the seat locations.

2. A method of using location-based trivia with mood-responsive capabilities of claim 1, further comprising:
assessing a mood of passengers the active players by analyzing vocal tone and speech patterns of the active players; and
basing one or more trivia questions based on the mood assessed of passengers of the active players.

3. A method of using location-based trivia with mood-responsive capabilities of claim 2, further comprising:
querying the players names of the active players via the one or more microphones at a start of the playing the trivia questions.

4. A method of using location-based trivia with mood-responsive capabilities of claim 3, further comprising:
configuring a number of channels and a processing chain topology based on a detected number of active the active players and the corresponding seat locations of the active players.

5. A method of using location-based trivia with mood-responsive capabilities of claim 4, wherein the GPS further includes retrieving the trivia questions based on a current location, a route, and/or upcoming destinations of the vehicle.

6. A method of using location-based trivia with mood-responsive capabilities of claim 5, further comprising:
using an audio processing system or acoustic noise reduction system to continuously ensure clear voice capture and accurate response analysis, including using one or more of the following components:
acoustic echo cancellation;
acoustic noise reduction;
acoustic source separation;
speech recognition engine; and/or
one or more large language models (LLMs).

7. A method of using location-based trivia with mood-responsive capabilities of claim 6, further comprising:
addressing, via one or more contest managers, the active players by the players names and/or tailoring questions and/or tasks based on the specific corresponding seat locations of the active players.

8. A method of using location-based trivia with mood-responsive capabilities of claim 1, further comprising:
using one or more user travel histories, such that, via a contest manager, uses the user travel histories to determine relative at least some of the trivia questions related to one or more travel destinations, the one or more travel destinations being part of the one or more travel histories.

9. A method of using location-based trivia with mood-responsive capabilities of claim 8, further comprising:
using an audio processing system or acoustic noise reduction system to continuously ensure clear voice capture and accurate response analysis, including using one or more of the following components:
acoustic echo cancellation;
acoustic noise reduction;
acoustic source separation;
speech recognition engine; and/or
one or more large language models (LLMs).

10. A non-transitory computer-readable storage medium, on which is recorded instructions for using location-based trivia with mood-responsive capabilities in a vehicle, wherein execution of the instructions, includes results in:
executing playing location-based trivia questions in the vehicle, based on global positioning system (GPS) coordinates;
executing vocal-based detecting player names and corresponding seat locations of active players detection, based on using one or more microphones within a the vehicle;
based on the detection of players names and their corresponding seat locations, customizing the trivia questions for one or more of the corresponding seat locations;
assessing a mood of passengers the active players by analyzing vocal tone and speech patterns of the active players;
basing one or more trivia questions based on the mood assessed of passengers, and querying the players names via one or more microphones at start of the trivia;
configure configuring one or more number of channels and processing chain topology based on the detected number of active players and their seat locations; and
retrieving the GPS retrieves relevant trivia questions via a GPS receiver based on a current location, a route, and/or upcoming destinations of the vehicle.

11. The non-transitory computer-readable storage medium of claim 10, of using location-based trivia with mood-responsive capabilities, wherein execution of the instructions results in, and includes:
using an audio processing system or acoustic noise reduction system to continuously ensure clear voice capture and accurate response analysis, including using one or more of the following components:
acoustic echo cancellation;
acoustic noise reduction;
acoustic source separation;
speech recognition engine; and/or
one or more large language models (LLMs).

12. The non-transitory computer-readable storage medium of claim 11, of using location-based trivia with mood-responsive capabilities, wherein execution of the instructions results in, and includes:
one or more contest managers addresses addressing players by name and/or tailor the trivia questions and/or tasks based on their specific seats and locations of the players.

13. A system of using location-based trivia with mood-responsive capabilities, comprising:
a global positioning system (GPS) receiver configured for providing GPS coordinates of a vehicle;
a configured for implementing location-based trivia questions, based on the global positioning system (GPS) coordinates; and
a configured for detecting or implementing vocal-based active players detection, using one or more on microphones within a vehicle,
wherein the system is configured to customize the trivia for one of more seat locations of the vehicle based on the detection of players names and the their seat locations, customizing the trivia for one or more seat locations.

14. A system of using location-based trivia with mood-responsive capabilities of claim 13, further comprising:
one of assessing a mood of passengers the active players by analyzing vocal tone and speech patterns; and
basing base one or more of the trivia questions based on the assessed mood assessed of the active passengers.

15. A system of using location-based trivia with mood-responsive capabilities of claim 14, further comprising:
an intelligent agent configured to keeps track of people’s preferences of the players, the preferences including:
biographies;
history; and/or
general knowledge/awareness.

16. A system of using location-based trivia with mood-responsive capabilities of claim 15, further comprising:
one or more user travel histories, such that a contest manager is configured to uses one or more of the user travel histories to determine relative the trivia questions related to travel destinations from the user travel histories.

17. A system of using location-based trivia with mood-responsive capabilities of claim 16, further comprising:
operable to configuring configure the a number of channels and a processing chain topology based on the a detected number of active the active players and their seat locations.

18. A system of using location-based trivia with mood-responsive capabilities of claim 17, wherein the GPS receiver is configured to retrieves relevant trivia questions based on a current location, a route, and/or upcoming destinations.

19. A system of using location-based trivia with mood-responsive capabilities of claim 18, further comprising:
an audio processing system or acoustic noise reduction configured to continuously ensure clear voice capture and accurate response analysis using one or more of the following components:
acoustic echo cancellation;
acoustic noise reduction;
acoustic source separation;
speech recognition engine; and/or
one or more large language models (LLMs).

20. A system of using location-based trivia with mood-responsive capabilities of claim 19, further comprising:
a digital assistant may be configured to initiate the trivia questions to engage one or more passengers of the active players.
